(19) United States
(12) Patent Application Publication
(10) Pub. No.: US 2010/0160576 A1
(43) Pub. Date: Jun. 24, 2010

(54) PERFLUORINATED POLY(OXYMETHYLENE) COMPOUNDS

(75) Inventors: Jamie L. Adcock, Knoxville, TN (US); Andrew J. Colvin, Knoxville, TN (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: University of Tennessee Research Foundation

(21) Appl. No.: 12/623,698

(22) Filed: Nov. 23, 2009

Related U.S. Application Data
(60) Provisional application No. 61/116,858, filed on Nov. 21, 2008.

(51) Int. Cl. C08G 16/04

(52) U.S. Cl. 525/473

(57) ABSTRACT

Compounds of Formula (I):

R₁—O—(CF₂—O)ₙ—R₁,

wherein: n is an integer from 2 to 100; and R₁ is perfluorinated alkyl or substituted perfluorinated alkyl are described. Also described are methods of preparing the compounds of Formula (I). For example, compounds of Formula (I) can be prepared by providing a poly(oxymethylene) compound and fluorinating the poly(oxymethylene) compound, for instance, via direct aerosol fluorination.

### CROSS-REFERENCE TO RELATED APPLICATION

The presently disclosed subject matter claims the benefit of U.S. Provisional Patent Application Ser. No. 61/116,858, filed Nov. 21, 2008, the disclosure of which is incorporated herein by reference in its entirety.

### GOVERNMENT INTEREST

This presently disclosed subject matter was made with U.S. Government support under Grant No. FA 9550-05-1-0342 awarded by the United States Air Force Office of Scientific Research. Thus, the U.S. Government has certain rights in the presently disclosed subject matter.

### TECHNICAL FIELD

The presently disclosed subject matter relates to perfluorinated poly(oxymethylene) compounds, such as perfluorinated poly(oxymethylene) dialkyl ethers, and the synthesis and use thereof.

### ABBREVIATIONS

| | |
|---|---|
| % = | percentage |
| ° C. = | degrees Celsius |
| ° F. = | degrees Fahrenheit |
| bp = | boiling point |
| cm = | centimeter |
| eq. = | equivalents |
| F₂ = | fluorine gas |
| FTNMR = | Fourier transform nuclear magnetic resonance |
| g = | grams |
| hr = | hours |
| hz = | Hertz |
| IR = | infrared |
| min = | minutes |
| mL = | milliliters |
| mm = | millimeters |
| MoF₆ = | molybdenum hexafluoride |
| mol = | moles |
| NMR = | nuclear magnetic resonance |
| POM = | poly(oxymethylene) ether |
| ppm = | parts-per-million |
| PTFE = | polytetrafluoroethylene |
| rpm = | revolutions-per-minute |
| r.t. = | room temperature |
| SF₄ = | sulfur tetrafluoride |
| SF₆ = | sulfur hexafluoride |
| UV = | ultraviolet |

### BACKGROUND

Perfluoropolyethers are highly regarded for their long liquid range (i.e., they are liquid over a wide range of temperatures), low vapor pressure, and high thermal and oxidative stability. Because of these properties, they have been used as high performance lubricants, sealants, elastomers, hydraulic fluids, and heat transfer fluids. Other uses for perfluoropolyethers, include, but are not limited to, as plastics and as blood substitutes.

Commercially available perfluoropolyethers include KRYTOX™ (E.I. DuPont de Nemours and Company, Wilmington, Del., United States of America) and FOMBLIN™ (Solvay Solexis, Inc., Thorofare, N.J., United States of America). These perfluoropolyethers are produced by the polymerization of hexafluoropropylene oxide or by photooxidative polymerization of perfluoro-olefins, utilizing oxygen and ozone, respectively. The FOMBLIN™ fluids have a slight advantage (10-15° F.) in their longer liquid range at low temperature. It has been suggested that the unusual liquid properties of the random FOMBLIN™ Z copolymer, which has the structure X—CF₂—O—(CF₂—CF₂—O)ₚ—(CF₂O)_{q}—CF₂—X, wherein p and q are 2 or 3, are a direct result of the inclusion of difluoromethylene oxide (—CF₂—O—) linkages, which can provide hinge-like flexibility.

While the synthesis of some types of perfluorinated polymers and oligomers are known, the synthesis of perfluorinated polymers containing multiple consecutive, non-random difluoromethylene oxide linkages has proven elusive. For example, attempts to polymerize carbonyl fluoride have not been successful. Given the potential high molecular flexibility of molecules containing multiple difluoromethylene oxide repeating units, there exists a ongoing need in the art for polymers and oligomers comprising perfluorinated poly(oxymethylene) units and methods for their synthesis.

### SUMMARY

In some embodiments, the presently disclosed subject matter provides a compound of Formula (I):

R₁—O—(CF₂—O)ₙ—R₁,

wherein n is an integer from 2 to 100; and R₁ is perfluorinated alkyl or substituted perfluorinated alkyl.

In some embodiments, n is an integer from 2 to 50. In some embodiments, n is an integer from 2 to 20. In some embodiments, n is an integer from 2 to 13. In some embodiments, n is an integer from 2 to 7.

In some embodiments, R₁ is perfluorinated alkyl. In some embodiments, R₁ is —CF₃. In some embodiments, R₁ is substituted perfluorinated alkyl and has a structure of formula: —R₂—X, wherein R₂ is perfluorinated alkylene and X is selected from the group consisting of saturated alkyl, alkenyl, alkynyl, substituted alkyl, aralkyl, aryl, substituted aryl, alkoxycarbonyl, aralkoxycarbonyl, aryloxycarbonyl, carboxy, carbamoyl, alkylcarbamoyl, aralkylcarbamoyl, arylcarbamoyl, chloro, iodo, and bromo.

In some embodiments, the presently disclosed subject matter provides a composition comprising one or more compounds of Formula (I):

R₁—O—(CF₂—O)ₙ—R₁,

wherein n is an integer from 2 to 100; and R₁ is perfluorinated alkyl or substituted perfluorinated alkyl. In some embodiments, the composition comprises two or more compounds of Formula (I). In some embodiments, the presently disclosed subject matter provides a heat transfer fluid, a lubricant, or a solvent comprising a compound of Formula (I).

In some embodiments, the presently disclosed subject matter provides a method of preparing a compound of Formula (I), wherein the method comprises providing a poly(oxymethylene) compound; and fluorinating the poly(oxymethylene) compound to provide a perfluorinated poly(oxymethylene) compound. In some embodiments, the poly(oxymethylene) compound has a structure of Formula (II):

R₃—O—(CH₂—O)ₙ—R₃,

wherein n is an integer from 2 to 100; and R₃ is selected from the group consisting of alkyl, substituted alkyl, aralkyl, aryl and substituted aryl.

In some embodiments, R₃ is alkyl and the compound of Formula (II) is a poly(oxymethylene) dialkyl ether. In some embodiments, R₃ is methyl and the compound of Formula (II) is a poly(oxymethylene) dimethyl ether. In some embodiments, R₃ is substituted alkyl, wherein the substituted alkyl is chloro-substituted alkyl or alkoxycarbonyl-substituted alkyl.

In some embodiments, providing the poly(oxymethylene) compound comprises contacting paraformaldehyde with a formaldehyde acetal in the presence of an acid, wherein the formaldehyde acetal has the structure CH₂(OR₄)₂, wherein each R₄ is independently alkyl or substituted alkyl. In some embodiments, one or both R₄ is substituted alkyl, wherein substituted alkyl is chloro-substituted alkyl. In some embodiments, each R₄ is alkyl. In some embodiments, each R₄ is methyl and the formaldehyde acetal is methylal. In some embodiments, the acid is sulfuric acid.

In some embodiments, fluorinating the poly(oxymethylene) compound is performed via direct fluorination. In some embodiments, fluorinating the poly(oxymethylene) compound is performed via aerosol direct fluorination. In some embodiments, the method further comprises grafting one or more alkyl group substituent to a terminal group of the perfluorinated poly(oxymethylene).

Accordingly, it is an object of the presently disclosed subject matter to provide perfluorinated poly(oxymethylene) compounds and methods for making perfluorinated poly(oxymethylene) compounds.

A certain object of the presently disclosed subject matter having been stated hereinabove, which is addressed in whole or in part by the presently disclosed subject matter, other objects and advantages will become apparent to those of ordinary skill in the art after a study of the following description of the presently disclosed subject matter and in the accompanying non-limiting Examples.

### DETAILED DESCRIPTION

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

### I. DEFINITIONS

Following long-standing patent law convention, the terms “a” and “an” mean “one or more” when used in this application, including the claims. Thus, “a compound” can refer to a plurality (i.e., two or more) compounds.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter. Thus, the term “about”, as used herein when referring to a value or to an amount of mass, weight, time, temperature, volume, or percentage is meant to encompass variations of ±20% or ±10%, more preferably ±5%, even more preferably ±1%, and still more preferably ±0.1% from the specified amount, as such variations are appropriate to perform the disclosed method.

The term “and/or” when used to describe two or more activities, conditions, or outcomes refers to situations wherein both of the listed conditions are included or wherein only one of the two listed conditions are included.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein the term “alkyl” refers to C₁₋₂₀ inclusive, linear (i.e., “straight-chain”), branched, cyclic, saturated or at least partially and in some cases fully unsaturated (i.e., alkenyl and alkynyl)hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₁₁ straight-chain alkyls. In other embodiments, “alkyl” refers, in particular, to C₁₋₆ straight-chain alkyls.

The alkyl group can be optionally substituted (i.e., a “substituted alkyl”) with one or more alkyl group substituents which can be the same or different, where “alkyl group substituent” includes but is not limited to alkyl, substituted alkyl, halo, arylamino, acyl, hydroxy, aryl, aryloxy, alkoxyl, alkylthio, arylthio, aralkyloxy, aralkylthio, carboxy, alkoxycarbonyl, oxo and cycloalkyl. Suitable substituted alkyls include, for example, benzyl, trifluoromethyl and the like. There can be optionally inserted along the alkyl chain one or more oxygen, sulfur or substituted or unsubstituted nitrogen atoms, wherein the nitrogen substituent is hydrogen, alkyl (also referred to herein as “alkylaminoalkyl”), or aryl. Optionally, there are no oxygen, sulfur or nitrogen atoms inserted along the alkyl chain.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “perfluorinated alkyl” refers to an alkyl group, as defined herein, wherein all or substantially all of the hydrogen atoms have been replaced with fluorine atoms. Perfluorination ideally indicates that every hydrogen or other replaceable atom has been replaced by a fluorine atom. However, in actual conditions, it can be difficult or impossible to replace every replaceable atom, or to detect whether every replaceable atom has in fact been replaced. Therefore, “perfluorination” is used herein in a non-ideal, functional sense to indicate that extensive fluorination (for example, of at least about 80%, 85%, 90%, 95%, 96%, 97%, 98%, 99%, or 99.5% of the replaceable atoms) has been achieved with the purpose and practical effect of replacing the large majority or substantially all of the hydrogen or other replaceable atoms in a compound with fluorine atoms. For example, an analysis might indicate that the economically optimal material for a given use might be achieved by curtailing the fluorination reaction, thereby reducing expenses, at a given level of fluorination even though it is known that a small percentage (20%, 15%, 10%, 5%, 4%, 3%, 2%, 1%) of residual hydrogen atoms remain within the compound. Despite the presence of such residual hydrogen atoms, a highly-fluorinated compound of this nature should be regarded as “perfluorinated.”

The term “substituted perfluorinated alkyl” refers to a perfluorinated alkyl group that comprises one or more non-hydrogen or non-fluorine substituent. Typically, the substituted perfluorinated alkyl group comprises only one non-fluorine/non-hydrogen substituent per carbon atom or less. In some embodiments, the substituted perfluorinated alkyl group comprises one, two or three non-hydrogen/non-fluorine substituents. Non-hydrogen/non-fluorine substituents can include, but are not limited to, alkyl (e.g., saturated branched or straight chain alkyl, alkene, and alkyne), aralkyl, aryl, substituted aryl (e.g., halo-substituted aryl, including perfluoroaryl), alkoxycarbonyl, aralkyoxycarbonyl, aralkoxycarbonyl, carboxy, chloro, bromo, iodo, amino, and the like.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, hydroxy, and/or alkylene. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl.

“Alkylene” refers to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Optionally, there are no oxygen, sulfur or nitrogen atoms inserted along the alkylene group. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

The term “aryl” is used herein to refer to an aromatic substituent which can be a single aromatic ring or multiple aromatic rings which are fused together, linked covalently, or linked to a common group such as a methylene or ethylene moiety. The common linking group can also be a carbonyl as in benzophenone or oxygen as in diphenylether. The term “aryl” specifically encompasses heterocyclic aromatic compounds. The aromatic ring(s) can include phenyl, naphthyl, biphenyl, diphenylether, diphenylamine and benzophenone among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

Specific examples of aryl groups include but are not limited to cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, and the like.

The aryl group can be optionally substituted (i.e., a “substituted aryl”) with one or more aryl group substituents which can be the same or different, where “aryl group substituent” includes alkyl, substituted alkyl, aryl, substituted aryl, aralkyl, hydroxy, alkoxyl, aryloxy, aralkoxyl, carboxy, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene and —NR′R″, where R′ and R″ can be each independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “arylalkyl” refers to the group alkyl-aryl. The aryl group can be, for example, phenyl or napthyl or can be heteroaryl. The alkyl can be cyclic or branched or further substituted, for example, by a halo, hydroxy, or nitro group. Exemplary arylalkyl compounds include, but are not limited to 4-tert-butylphenyl, 3-methylphenyl, 2-isopropylphenyl, 2,6-di-isopropylphenyl, 2,6-dimethylphenyl, 3,5-di-tert-butylphenyl, and 2,4,6-trimethylphenyl.

The term “alkoxy” is used herein to refer to the —OR radical, where R is selected from the group consisting of alkyl, substituted alkyl, cycloalkyl, substituted cycloalkyl, heterocycloalkyl, substituted heterocycloalkyl, silyl groups and combinations thereof as described herein. Suitable alkoxy radicals include, for example, methoxy, ethoxy, benzyloxy, t-butoxy, and the like. A related term is “aryloxy” where R is selected from the group consisting of aryl, substituted aryl, heteroaryl, substituted heteroaryl, and combinations thereof. Examples of suitable aryloxy radicals include phenoxy, substituted phenoxy, 2-pyridinoxy, 8-quinalinoxy and the like.

The term “amino” is used herein to refer to the group —NZ₁Z₂, where each of Z₁ and Z₂ is independently selected from the group consisting of hydrogen; alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof. Additionally, the amino group can be represented as N⁺Z₁Z₂Z₃, with the previous definitions applying and Z₃ being either H or alkyl.

“Aralkyloxyl” and “aralkoxy” refer to an aralkyl-O— group wherein the aralkyl group is as previously described. An exemplary aralkyloxyl group is benzyloxyl.

“Alkoxycarbonyl” refers to an alkyl-O—C(═O)— group. Exemplary alkoxycarbonyl groups include methoxycarbonyl, ethoxycarbonyl, butyloxycarbonyl, and t-butyloxycarbonyl.

“Aryloxycarbonyl” refers to an aryl-O—C(═O)— group. Exemplary aryloxycarbonyl groups include phenoxy- and naphthoxy-carbonyl.

“Aralkoxycarbonyl” refers to an aralkyl-O—C(═O)— group. An exemplary aralkoxycarbonyl group is benzyloxycarbonyl.

“Carbamoyl” refers to an H₂N—C(═O)— group.

“Alkylcarbamoyl” refers to a R′RN—C(═O)— group wherein one of R and R′ is hydrogen and the other of R and R′ is alkyl and/or substituted alkyl as previously described. “Aralkylcarbamoyl” and “arylcarbamoyl” refers to R′RN—CO— groups wherein one of R and R′ is aralkyl or aryl, respectively.

The term “carbonyl” refers to the —(C═O)— group.

The term “carboxyl” refers to the —C(═O)OH or —C(═O)O⁻ group.

The terms “halo”, “halide”, or “halogen” as used herein refer to fluoro, chloro, bromo, and iodo groups.

The term “hydroxyalkyl” refers to an alkyl group substituted with an —OH group.

“Independently selected” means that in a multiplicity of R groups with the same name, each group can be identical to or different from each other (e.g., one R₁ can be an alkyl, while another R₁ group in the same compound can be aryl; one R₂ group can be H, while another R₂ group in the same compound can be alkyl, etc.).

The term “inert gas” refers to gases that are chemically non-reactive (e.g., to particular reaction conditions). Inert gases can include, but are not limited to, noble gases, e.g., helium, argon, neon, krypton, xenon or radon gas. Inert gases can also include nitrogen gas.

As used herein, the term “aerosol” refers to a gaseous suspension of liquid, solid, or liquid-coated solid particles.

### II. COMPOUNDS AND COMPOSITIONS OF FORMULA (I)

Previously reported perfluorinated poly(oxyalkylene) polymers generally comprise repeat units that include at least one carbon-carbon bond. For example, previously reported polymers that comprise —[OCF₂]— repeat units also comprise other types of repeat units (e.g., —[OCF₂CH₂]—, —[OCF(CF₃)CF₂]—, and/or —[OCF₂CF₂CF₂]— units) interspersed with the —[OCF₂]— units such that the polymer chain (e.g., the polymer chain exclusive of terminal groups) includes carbon-carbon bonds. Attempts in the art to synthesize polymers comprising mainly —[OCF₂]— repeat units by polymerizing carbonyl fluoride (i.e., C(═O)F₂) have led to the production of unstable intermediates that depolymerize. Thus, previous to the presently disclosed subject matter, it has been unclear if stable compounds comprising multiple consecutive single bonds between oxygen atoms and —CF₂-groups could be made. The presently disclosed subject matter is based at least in part on the finding that stable perfluorinated poly(oxymethylene) polymers can be prepared when the oxygen-carbon bonds are made prior to fluorination.

Thus, in some embodiments, the presently disclosed subject matter provides perfluorinated poly(oxymethylene) compounds having the structure of Formula (I):

R₁—O—(CF₂—O)ₙ—R₁,

wherein n is an integer from 2 to 100, and R₁ is a perfluorinated alkyl or substituted perfluorinated alkyl. In some embodiments, n is an integer from 2 to 50. In some embodiments, n is an integer from 2 to 20. In some embodiments, n is an integer from 2 to 13 (i.e., 2, 3, 4, 5, 6, 7, 8, 9, 10, 11, 12, or 13). In some embodiments, n is an integer from 2 to 7 (i.e., 2, 3, 4, 5, 6, or 7).

In some embodiments, R₁ is a perfluorinated alkyl. In some embodiments, R₁ comprises between 1 and 6 carbon atoms. The perfluorinated alkyl group can be straight-chain, branched, or cyclic perfluorinated alkyl. Thus, R₁ can be perfluorinated alkyl, wherein the alkyl is selected from the group including, but not limited to, methyl, ethyl, propyl, isopropyl, cyclopropyl, n-butyl, sec-butyl, tert-butyl, n-pentyl, isopentyl, hexyl, and the like. Thus, in some embodiments, the presently disclosed subject matter provides perfluorinated poly(oxymethylene) dialkyl ethers. In some embodiments, the compound is a perfluorinated poly(oxymethylene) dimethyl ether and R₁ is —CF₃.

In some embodiments, R₁ is substituted perfluorinated alkyl. In some embodiments, the substituted perfluorinated alkyl has the formula —R₂—X, wherein R₂ is perfluorinated alkylene and X a group other than hydrogen or fluorine. For example, X can be selected from the group including, but not limited to, saturated alkyl, alkenyl, alkynyl, substituted alkyl (e.g., hydroxy-substituted alkyl or amino-substituted alkyl), aralkyl, aryl, substituted aryl, alkoxycarbonyl, aralkoxycarbonyl, aryloxycarbonyl, carboxy, carbamoyl, alkylcarbamoyl, aralkylcarbamoyl, arylcarbamoyl, chloro, iodo, bromo, and the like. In some embodiments, the substituted aryl or aralkyl group is itself perfluorinated aryl (e.g., pentafluorophenyl). Thus, in some embodiments, the compound of Formula (I) can include non-perfluorinated and/or unsaturated groups grafted to otherwise perfluorinated terminal/capping groups of a perfluorinated poly(oxymethylene) chain.

The presently disclosed subject matter encompasses both pure compounds of Formula (I) and mixtures thereof. In some embodiments, the presently disclosed subject matter provides compositions comprising one or more compounds of Formula (I). In some embodiments, the compositions can comprise two or more compounds of Formula (I). For example, the compositions can comprise two or more compounds of Formula (I), wherein each of the two or more compounds of Formula (I) has a different number of CF₂O repeat units. Stated another way, the presently disclosed subject matter can related to both monodisperse and polydisperse perfluorinated poly(oxymethylene) dialkyl ethers. The two or more compounds of Formula (I) in the same composition or mixture can also differ by the identity of the R groups.

The physical properties (e.g., boiling point, melting point, flow point, density, viscosity, etc.) of the compounds of Formula (I) can vary depending on the identity of n and R₁. As described further hereinbelow in representative examples of the presently disclosed subject matter, compounds of Formula (I) wherein n is between 3 and 5 can have boiling points between about 61.5° C. and about 112.9° C. In some embodiments, the compound of Formula (I) can have a low flow point (e.g., less then or equal to about −25, −50, −75, −100, −125, −150, or −175° C.). In some embodiments, the compound of Formula (I) has a flow point of about −177° C.

The compounds and compositions of the presently disclosed subject matter can be of use as, for example, lubricants, heat transfer fluids, solvents (e.g., inert solvents), plasticizers, waxes, sealing liquids, refrigerants, surface active agents, oil and water repelling agents, diluents, and the like. Thus, in some embodiments, the presently disclosed subject matter provides a heat transfer fluid, a lubricant or a solvent comprising a compound of Formula (I). Heat transfer fluids comprising the compounds of Formula (I) can find use in many areas and industries, including, but not limited to, electronics, the aerospace and/or space industry, automotives, refrigeration and/or heating, air conditioning, and in the power industry. In particular, compositions comprising compounds of Formula (I) (e.g., compounds of Formula (I) with low flow points) can be useful in heat transfer fluids in applications related to the space industry (e.g., in space suits).

### III. METHODS OF PREPARING COMPOUNDS OF FORMULA (I)

In some embodiments, the presently disclosed subject matter provides a method of preparing a compound of Formula (I), the method comprising: providing a poly(oxymethylene) compound; and fluorinating the poly(oxymethylene) compound.

Poly(oxymethylene)s (also referred to as POMs or as polyformals) can be prepared by any of a number of methods of synthesis. In some embodiments, the poly(oxymethylene) compounds can have the formula:

R₃O—(CH₂O)ₙ—R₃

wherein n is an integer greater than 1 and R₃ is an alkyl, substituted alkyl, aralkyl, aryl or substituted aryl group. In some embodiments, R₃ has between 1 and 6 carbon atoms (i.e., 1, 2, 3, 4, 5, or 6 carbon atoms).

In some embodiments, the poly(oxymethylene) is a poly(oxymethylene) dialkyl ether and R₃ is a straight-chain, branched or cyclic saturated alkyl. In some embodiments, R₃ is methyl. When R₃ is methyl, the ether is a poly(oxymethylene) dimethyl ether.

Poly(oxymethylene)s can be prepared according to any suitable method as would be apparent to one of ordinary skill in the art upon a review of the instant disclosure. Several methods have been previously reported. As one example, poly(oxymethylene)s can be prepared by the acid-catalyzed polymerization of formaldehyde in the presence of an alcohol or of a dialkyl formal as shown in equations 1 and 2:

2ROH+mCH₂O→RO(CH₂O)ₘR+H₂O (1)

RO(CH₂O)R+(m−1)CH₂O→RO(CH₂O)ₘR (2)

Polyoxymethylene dimethyl ethers can also be prepared by heating polyoxymethylene glycol or paraformaldehyde with methanol in the presence of trace sulfuric acid or hydrochloric acid in a sealed tube at an elevated temperature. The resulting decomposition reactions form carbon dioxide and lead to the formation of dimethyl ethers. The average molecular weight of the ether product can increase with the ratio of paraformaldehyde or polyoxymethylene to methanol. At a paraformaldehyde to methanol ratio of 6:1, polymers can be obtained having more than 100 repeat units. The products can be purified, for example, by washing with sodium sulfite solution, which does not dissolve dimethyl ethers, and then fractionating by fractional crystallization.

Another exemplary synthesis of POMs involves the reaction of paraformaldehyde with methylal (CH₃OCH₂OCH₃). For instance, methylal can be heated with paraformaldehyde or a concentrated formaldehyde solution in the presence of sulfuric acid. This can afford polyoxymethylene dimethyl ethers with from 2 to 4 formaldehyde units per molecule.

The preparation of polyoxymethylene dimethyl ethers having a molar mass of from 80 to 350, corresponding to n=1-10, can also be carried out by reaction of 1 part of methylal with 5 parts of paraformaldehyde in the presence of 0.1% by weight of formic acid at a temperature of from 150 to 240° C., or by reaction of 1 part of methanol with 3 parts of paraformaldehyde at a temperature of from 150 to 240° C.

In addition, polyoxymethylene dimethyl ethers can be prepared by reacting a starting stream comprising methanol and formaldehyde in the presence of an acidic catalyst and simultaneous separation of the reaction products in a catalytic distillation column. This can afford methylal, methanol, water and polyoxymethylene dimethyl ethers.

Polyoxymethylene dimethyl ethers with from 2 to 6 formaldehyde units in the molecule can be prepared by reaction of methylal with paraformaldehyde in the presence of trifluoromethanesulfonic acid (i.e., triflic acid). This forms polyoxymethylene dimethyl ethers where n=2-5 with a selectivity of 94.8%, the dimer (n=2) being obtained to an extent of 49.6%.

In some embodiments, the poly(oxymethylene) compound can be provided by contacting paraformaldehyde with a formaldehyde acetal in the presence of an acid. The formaldehyde acetal can have the structure CH₂(OR₄)₂, wherein each R₄ is independently selected from the group including, but not limited to, alkyl or substituted alkyl. In some embodiments, each R₄ is alkyl (e.g., C1-C6 alkyl). In some embodiments, each R₄ is methyl and the formaldehyde acetal is methylal. In some embodiments, one or both R₄ is substituted alkyl (e.g., chloro-substituted alkyl).

Any suitable acid can be used. Suitable acids include, but are not limited to, strong acids (i.e., acids that completely dissociate in water, such as but not limited to HCl, HBr, sulfuric acid, a sulfonic acid, etc) and strong acid resins (e.g., a sulfonic acid-substituted polymeric resin, such as, but not limited to a sulfonic acid substituted polystyrene or polystyrene-divinylbenzene resin). In some embodiments, the acid is sulfuric acid or a sulfonic acid (e.g., triflic acid or p-toluenesulfonic acid). In some embodiments, the acid is sulfuric acid. In some embodiments, the contacting is performed at a temperature ranging between about 55° C. and about 115° C. (e.g., about 55, 60, 65, 70, 75, 80, 85, 90, 95, 100, 105, 110, or 115° C.). In some embodiments, the poly(oxymethylene) compound is a mixture of oligomers wherein for each oligomer n is an integer between about 2 and about 13 (e.g., 2, 3, 4, 5, 6, 7, 8, 9, 10, 11, 12, or 13).

If desired, any polydisperse poly(oxymethylene) mixture prepared can be separated to provide a monodisperse oligomer or a small subset of oligomers of closely related size (i.e., wherein n ranges over 10 or less integers, 5 or less integers, or 3 or less integers). Different size oligomers can be separated from one another by any convenient method, including, but not limited to filtration, extraction, distillation, crystallization, liquid chromatography, gas chromatography, and the like. Alternatively, separation of different size oligomers can be performed after fluorination. In some embodiments, separation of the perfluorinated compounds of Formula (I) can be accomplished more easily than separation of the mixtures of POMs from which they are made.

Fluorination can be done either directly or indirectly. Direct fluorination implies that a substance is contacted with fluorine that is in the elemental form, as fluorine gas (F₂). This type of reaction can be highly exothermic, and can lead to adverse effects such as breakage of carbon-carbon bonds. Therefore, direct fluorination can be carried out at low temperatures or at initially low temperatures (e.g., less than room temperature) using fluorine gas which is diluted during the initial contact with an inert gas such as helium or nitrogen. The concentration of fluorine can be increased gradually or stepwise until pure fluorine gas surrounds the substance. The temperature and pressure of the gas can also be increased during the fluorination process. In some embodiments, the temperature can vary between about −80° C. and about 150° C.).

Indirect fluorination indicates that the substance to be fluorinated is contacted with a compound that contains fluorine, such as sulfur tetrafluoride (SF₄), sulfur hexafluoride (SF₆), or molybdenum hexafluoride (MoF₆). When heated or otherwise manipulated, such compounds can be induced to release fluorine atoms. The released fluorine atoms react with the contacted substance to produce a desired fluorinated or perfluorinated substance.

In some embodiments, the fluorination is performed via direct fluorination. Direct fluorination can be performed according to any suitable method as would be apparent to one of ordinary skill in the art upon a review of the instant disclosure, including, but not limited to, LaMar fluorination or variations thereof (e.g., cryogenically controlled direct fluorination), aerosol direct fluorination, or liquid-phase direct fluorination. More particularly, the LaMar process can involve condensing a compound to be fluorinated in a tube at low temperature (e.g., in the presence of copper turnings or nickel turnings). Fluorine gas, which is initially diluted in an inert gas (e.g., nitrogen) can be added. The concentration of fluorine gas and the temperature can be increased as the reaction proceeds. In liquid-phase direct fluorination, the compound to be fluorinated can be injected at a controlled rate into an inert solvent (e.g., a fluorocarbon solvent, or a chlorofluorocarbon solvent) which is saturated with fluorine gas and is under ultraviolet irradiation.

In some embodiments, the direct fluorination is performed via aerosol direct fluorination. The aerosol direct fluorination process involves the adsorption of organic compounds onto aerosol particles (e.g., sodium fluoride particles) followed by the free radical addition of elemental fluorine to the carbon skeleton. As described hereinabove with regard to other types of direct fluorination, unwanted side reactions can be minimized by dilution of fluorine with an inert gas (e.g., helium, nitrogen, krypton, argon) and low reaction temperatures. In some embodiments, the reaction temperature can be increased over time during the course of the fluorination reaction (e.g., about −20° C. for the first stage of a perfluorination reaction and about 0° C. for a second stage of a perfluorination reaction). Perfluorination can also involve a UV photochemical finishing third stage.

For example, aerosol direct fluorination can be conducted in a reactor that has different zones wherein temperature can be controlled individually. Thus, the different zones of the reactor can be held at different temperatures, such that the reaction temperature increases as the aerosol comprising the compound to be fluorinated flows (e.g., in an inert carrier gas, such as helium) through the reactor. Temperatures in the zones used for early stages of fluorination reactions can be between about −78° C. and about 0° C., for example. Temperatures in zones used in later stages of fluorination reactions can be up to about room temperature (e.g., about to about 20, 21, 22, 23, 24, or 25° C.), for example. The reactor can also have multiple inlets for fluorine gas (or mixtures of fluorine gas and inert gas) so that the concentration of fluorine gas can be increased as the aerosol comprising the compound to be fluorinated flows through the reactor.

The reactor can include a photochemical zone, wherein a reaction mixture comprising partially fluorinated compound can be irradiated with UV light (e.g., from a mercury arc lamp). In some embodiments, the UV light can have a wavelength ranging between about 250 and about 350 nm. Use of an irradiation zone to complete fluorination of a partially fluorinated compound can reduce the overall fluorination time or the amount of fluorine gas need to provide the perfluorinated compound.

In some embodiments, the reactor can include an aerosol generating zone, wherein sodium fluoride or other carrier particles can be treated with a vapor stream comprising vaporized hydrocarbon substrate. The aerosol particles comprising the substrate can then be carried in an inert gas carrier gas into the reaction zones of the reactor where fluorine is present. The aerosol generation zone can be chilled (e.g., to between about −200° C. to −150° C.) to assist in the condensation of the substrate to the carrier particles.

Following fluorination, material exiting a reactor or one of the zones of the reactor (e.g., the photochemical zone of the reactor) can be directed into one or more traps, to collect product and/or to treat the reaction mixture to remove water and hydrogen fluoride, for example, through the use of hydrogen fluoride scavengers, such as sodium or potassium fluoride, and the use of molecular sieves. Excess fluorine gas can be absorbed in, for example, an alumina trap.

In some embodiments, R₃ is a substituted alkyl group, comprising one or more alkyl group substituent that can survive a given set of fluorination conditions and/or can provide a reactive group that can serve as a point to graft other groups (i.e., aryl, halo-substituted aryl (including perfluorinated aryl, such as pentafluorophenyl), alkene, or alkynyl groups) onto the terminal group or capping groups of a perfluorinated poly(oxymethylene). For example, in some embodiments, R₃ is chloro-substituted alkyl or comprises an ester (e.g., an alkoxycarbonyl-substituted alkyl group). Depending on fluorination conditions, the chloro-carbon bond of the chloro-substituted alkyl can remain intact, providing a chloro-substituted perfluorinated poly(oxymethylene) compound that can be further reacted via substitution of the chloro group. Also depending upon the fluorination conditions, alkyl components of ester groups can become perfluorinated or the ester can react to form an acid fluoride. Either the perfluorinated ester or the acid fluoride can be sites of further reaction, and additional components can be grafted onto the terminal groups of the perfluorinated poly(oxymethylene). Thus, in some embodiments, the method can further comprises grafting one or more alkyl group substituent to a terminal group of the perfluorinated poly(oxymethylene) to form the compound of Formula (I). Suitable reactions and reagents for grafting substituents to the perfluorinated poly(oxymethylene) compound would be readily apparent to one of ordinary skill in the art upon a review of the instant disclosure.

### EXAMPLES

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein.

### Example 1

### Preparation of Poly(Oxymethylene) Dimethyl Ethers

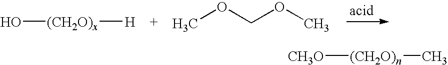

Paraformaldehyde (45 g 1.5 mol, 30 g/mol CH₂O eq.) was weighed into a 500 mL heavy walled glass reactor fitted with an O-ring joint with a polytetrafluoroethylene (PTFE) seal and KONTES™ 0-4 mm Hivac Stopcock (Kontes Glass Company, Vineland, N.J., United States of America). A magnetic stirrer bar was introduced and the joint sealed. The reactor was flushed with dry nitrogen. Methylal (48 mL, 41.3 g, 0.54 mol) was added and stirring at 100 rpm was initiated. After thorough mixing, 1.0 mL (2 g) reagent grade sulfuric acid was added. The hotplate-stirrer was set to 55° C. and after a minute or so of boiling when methylal vapor reached the stopcock base, the stopcock was closed. At 30 minute intervals the temperature was raised to 65° C., 75° C., then to 85° C. where it remained overnight. The next day the temperature was increased at 2 hour (hr) intervals to 95° C., 105° C. and to 115° C. overnight. The next day the reactor was cooled while stirring, opened and the contents were neutralized and made basic by careful addition of 100 mL of sodium methoxide/methanol solution made by reacting/dissolving 1.6 g freshly cut sodium metal in 100 mL of dry methanol.

The mixture of solid and liquid was filtered using a Buchner funnel and cellulose filter paper. The solid was washed several times with dry methanol. The washings were added to the filtrate. The combined filtrate washings were transferred to a 250 mL 14/20 flask with stir-bar and rigged for fractional distillation through a 12 cm Vigreaux column. Methanol/methylal was distilled off until the head reached 70° C. The pot material, a mixture of liquid and solid, was transferred to a 100 mL 14/20 flask and rigged for high vacuum distillation in a special still designed to strip volatiles from lower volatility oil under dynamic vacuum. Thus residual methanol, methylal, trioxane and CH₃O(CH₂O)ₙCH₃ (n=2 and 3) were removed while the distilling oil (5-10 mL) was identified by ¹H NMR as almost pure CH₃O(CH₂O)₄CH₃, a free-flowing colorless oil. The approximately 20 mL of pot residue semi-solidified on cooling and was extracted with chloroform to yield about 10 mL of CH₃O(CH₂O)ₙCH₃ (n=6 and 7), an oily colorless liquid, confirmed by ¹H NMR after removal of the chloroform.

The filter cake from the Buchner filtration was placed in a cellulose extraction thimble and extracted with chloroform in a Soxhlet extractor for two days. On removal of the chloroform the extract yielded about 15 grams of CH₃O(CH₂O)ₙCH₃ (n=8-13) which yielded about 5 grams of the oligomer where n=8 and 9, a waxy semisolid, which was petroleum ether soluble, and about 5 g of n=11-13, a white friable solid, which was insoluble in petroleum ether.

### Example 2

### Perfluorinated Poly(oxymethylene) Dimethyl Ethers

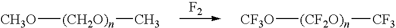

The perfluorinated poly(oxymethylene) dimethyl ethers examples were fluorinated by an aerosol direct fluorination process as summarized hereinabove. The poly(oxymethylene) dimethyl ether compounds to be fluorinated were synthesized by the acid catalyzed reaction of paraformaldehyde and methylal as described in Example 1, purified, and kept under dry nitrogen until needed. A typical fluorination involved the controlled delivery of the ether at 1 mL/hr to the aerosol fluorinator. The crude product from the reactor was treated with 10% aqueous sodium carbonate (e.g., to remove acidic contaminants from the fluorination, such as, HF and/or acidic derivatives of chain cleavage reactions), followed by fractionation on a vacuum line. Perfluorination was confirmed by Fourier transform infrared spectroscopy using a Bomem infrared spectrometer (ABB-Bomem Inc., Quebec, Canada). Purification of each compound was accomplished by gas chromatography using a BENDIX™ 2300 gas chromatograph (Honeywell International Inc., Morristown, N.J., United States of America) with a SE-52 phenyl, methyl silicone column. A center-cut was taken from the major product (purity ≧99%), and the structure confirmed by ¹⁹F NMR using a VARIAN™ 300 MHz NMR instrument (Varian, Palo Alto, Calif., United States of America).

Characterization of the perfluorinated poly(oxymethylene) dimethyl ether oligomers produced is provided below in Table 1. The perfluorinated ethers were stable when stored at room temperature. For example, when the purified perfluorinated pentamer (i.e. the compound wherein n is 5, (CF₃—O—(CF₂O)₅—CF₃)) was stored in a closed glass flask for one year at room temperature, the compound remained pure, showing no decomposition. In flow point studies, the pentamer flowed off a temperature monitored drip tip at −177° C. (±2° C.), while “frost” formed during condensation of the pentamer became clear at about −185° C., indicating that the pentamer had become fluid. Thus, given the pentamer boiling point of approximately 113° C., the pentamer has a liquid range nearly 300° C.

### Example 2.1

A 5.25 mL sample of poly(oxymethylene) dimethyl ethers, CH₃O(CH₂O)ₙCH₃, containing n=2 (5%), n=3 (80%), n=4 (15%) was fluorinated, hydrolysed, dried and fractionated. Gas chromatographic separation at 100° C. produced a series of products reflecting the distribution of input materials but also containing perfluorinated methylal (i.e., CF₃OCF₂OCF₃) in small quantities. Isolation of carbonyl fluoride prior to hydrolysis indicated some degradation of starting material. Overall yields were in excess of 50%.

### Example 2.2

A 5 mL sample of poly(oxymethylene) dimethyl ethers, CH₃O(CH₂O)ₙCH₃, containing principally n=4 and 5 but also some n=3 and 6 was fluorinated, hydrolysed, dried and fractionated. Gas chromatographic separation at 100° C. produced a series of products reflecting the distribution of input materials: perfluorinated n=2 and 3 (20%), n=4 (35%), n=5 (40%), and n=6 in small quantities. Overall yields were in excess of 50%.

### Example 2.3

A 5 mL sample of poly(oxymethylene) dimethyl ethers, CH₃O(CH₂O)ₙCH₃, containing principally n=6 and 7 but also some n=4 and 5 was fluorinated, hydrolysed, dried and fractionated. Gas chromatographic separation at 100° C. produced a series of products reflecting the distribution of input materials: perfluorinated n=1 (0.4%), 2 (1%), 3 (2%), 4 (7%), 5 (28%), 6 (42%) and n=7 (19%). Overall yields were in excess of 50%.

TABLE 1
Characterization of Perfluorinated Poly(oxy-methylene) Dimethyl Ethers
(CF₃—O—(CF₂O)ₙ—CF₃).

| | | | | ¹⁹F FTNMR Spectra |
|---|---|---|---|---|
| | | IR Diag. | bp ° C. @ | chemical shift ppm vs CFCl₃-multiplet |
| n = | r.t. min. | cm⁻¹ | torr | (integral) |
| 1 | 8.1 | 1132 | | [CF₃—O—]₂CF₂ |
| | | | | −57.6 t (6) −56.1 hept (2) |
| | | | | J = 9 hz |
| 2 | 8.9 | 1113 | | [CF₃—O—CF₂—O—]₂O |
| | | | | −57.54 t (6) −56.11 q (3.8) |
| | | | | J = 9 hz |
| 3 | 9.4 | 1092 | 61.5757 | [CF₃—O—CF₂—O—]₂CF₂ |
| | | | | −57.6 t (6) −56.1 hex (4) −55.7 pen (2) |
| | | | | J = 9 hz; J = 10 hz |
| 4 | 10.3 | 1077 | 89.0753 | [CF₃—O—CF₂—O—CF₂—]₂O |
| | | | | −57.5 t (6) −56.0 hex (4) −55.6 pen (2) |
| | | | | J = 8.2 hz; J = 8.7 hz, J = 8.2 hz |
| 5 | 11.6 | 1068 | 112.9753 | [CF₃—O—CF₂—O—CF₂—O—]₂CF₂ |
| | | | | −57.6 t (6) −56.1 mult (4) −55.6 mult |
| | | | | (5.6) |
| | | | | J = 8.7 hz; J = 8.7 hz, J = 9.8 hz |
| 6 | 13.9 | 1060 | | [CF₃—O—CF₂—O—CF₂—O—CF₂—]₂O |
| 7 | 17.2 | | | [CF₃—O—CF₂—O—CF₂—O—CF₂—O—]₂CF₂ |

### REFERENCES

The references listed below are incorporated herein by reference to the extent that they supplement, explain, provide a background for, or teach methodology and/or techniques employed herein.
J. L. Adcock et al., Journal of the American Chemical Society, 103: 6937-6947 (1981).
J. L. Adcock and M. L. Cherry, Journal of Fluorine Chemistry, 30: 343-350 (1985).
J. L. Adcock and M. L. Cherry, Industrial Engineering and Chemical Research, 26: 208-215 (1987).
European Patent Specification No. 1 070 755.
G. E. Gerhardt, et al., J. Org. Chem., 43: 4505 (1978).
G. E. Gerhardt, et al., J. Polymer Science: Polymer Chemistry Ed. 18: 157-168 (1979).
G. E. Gerhardt, et al., J.C.S. Perkin I, 1321 (1981).
U.S. Pat. No. 2,449,469.
U.S. Pat. No. 3,985,810.
U.S. Pat. No. 4,281,119.
U.S. Pat. No. 4,330,475.
U.S. Pat. No. 4,855,112.
U.S. Pat. No. 5,746,785.
U.S. Pat. No. 6,392,102.
U.S. Pat. No. 6,534,685.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A compound of Formula (I):
R₁—O—(CF₂—O)ₙ—R₁,
wherein:
n is an integer from 2 to 100; and
R₁ is perfluorinated alkyl or substituted perfluorinated alkyl.

2. The compound of claim 1, wherein n is an integer from 2 to 50.

3. The compound of claim 1, wherein n is an integer from 2 to 20.

4. The compound of claim 1, wherein n is an integer from 2 to 13.

5. The compound of claim 1, wherein n is an integer from 2 to 7.

6. The compound of claim 1, wherein R₁ is perfluorinated alkyl.

7. The compound of claim 1, wherein R₁ is —CF₃.

8. The compound of claim 1, wherein R₁ is substituted perfluorinated alkyl and has a structure of formula: —R₂—X, wherein R₂ is perfluorinated alkylene and X is selected from the group consisting of saturated alkyl, alkenyl, alkynyl, substituted alkyl, aralkyl, aryl, substituted aryl, alkoxycarbonyl, aralkoxycarbonyl, aryloxycarbonyl, carboxy, carbamoyl, alkylcarbamoyl, aralkylcarbamoyl, arylcarbamoyl, chloro, iodo, and bromo.

9. A composition comprising one or more compounds of Formula (I):
R₁—O—(CF₂—O)ₙ—R₁,
wherein:
n is an integer from 2 to 100; and
R₁ is perfluorinated alkyl or substituted perfluorinated alkyl.

10. The composition of claim 9, wherein the composition comprises two or more compounds of Formula (I).

11. A heat transfer fluid comprising a compound of claim 1.

12. A lubricant comprising a compound of claim 1.

13. A solvent comprising a compound of claim 1.

14. A method of preparing a compound of Formula (I):
R₁—O—(CF₂—O)ₙ—R₁,
wherein:
n is an integer from 2 to 100; and
R₁ is a perfluorinated alkyl or substituted perfluorinated alkyl;
the method comprising:
providing a poly(oxymethylene) compound; and
fluorinating the poly(oxymethylene) compound to provide a perfluorinated poly(oxymethylene) compound.

15. The method of claim 14, wherein the poly(oxymethylene) compound has a structure of Formula (II):
R₃—O—(CH₂—O)ₙ—R₃,
wherein:
n is an integer from 2 to 100; and
R₃ is selected from the group consisting of alkyl, substituted alkyl, aralkyl, aryl and substituted aryl.

16. The method of claim 15, wherein R₃ is alkyl and the compound of Formula (II) is a poly(oxymethylene) dialkyl ether.

17. The method of claim 16, wherein R₃ is methyl and the compound of Formula (II) is a poly(oxymethylene) dimethyl ether.

18. The method of claim 15, wherein R₃ is substituted alkyl, wherein the substituted alkyl is chloro-substituted alkyl or alkoxycarbonyl-substituted alkyl.

19. The method of claim 15, wherein providing the poly(oxymethylene) compound comprises contacting paraformaldehyde with a formaldehyde acetal in the presence of an acid, wherein the formaldehyde acetal has the structure CH₂(OR₄)₂, wherein each R₄ is independently alkyl or substituted alkyl.

20. The method of claim 19, wherein one or both R₄ is substituted alkyl, wherein substituted alkyl is chloro-substituted alkyl.

21. The method of claim 19, wherein each R₄ is alkyl.

22. The method of claim 19, wherein each R₄ is methyl and the formaldehyde acetal is methylal.

23. The method of claim 19, wherein the acid is sulfuric acid.

24. The method of claim 14, wherein fluorinating the poly(oxymethylene) compound is performed via direct fluorination.

25. The method of claim 14, wherein fluorinating the poly(oxymethylene) compound is performed via aerosol direct fluorination.

26. The method of claim 14, wherein the method further comprises grafting one or more alkyl group substituents to a terminal group of the perfluorinated poly(oxymethylene).
